(19) United States
(12) Patent Application Publication
(10) Pub. No.: US 2026/0176093 A1
(43) Pub. Date: Jun. 25, 2026

(54) CONTROL SYSTEM AND METHOD FOR LOADING DOCK EQUIPMENT

(71) Applicant: OVERHEAD DOOR CORPORATION, Lewisville, TX (US)

(72) Inventor: P. Alan Larson, Flower Mound, TX (US)

(21) Appl. No.: 19/000,289

(22) Filed: Dec. 23, 2024

(51) Int. Cl. B65G 69/28; B65G 69/00

(52) U.S. Cl. CPC B65G 69/2882; B65G 69/003

(57) ABSTRACT

A control system for a loading dock includes: a controller operatively connected to control loading dock equipment; sensors operatively connected to the controller; output devices operatively connected to the controller and configured to provide a visual output; input devices operatively connected to the controller and configured allow a user to enter inputs into the controller; wherein the controller is configured to display data received from at least three of the sensors on at least one display screen and allow a user to control at least three of the pieces of loading dock equipment via at least two of the input devices. Some embodiments include a method of controlling loading dock equipment.

### TECHNICAL FIELD

The present disclosure relates generally to control systems for a loading dock, and more particularly to a control system for a loading dock equipped with multiple types of equipment such as upward acting doors, operators for the upward acting doors, vehicle restraints, a lock leveler, cameras, indicator lights, vehicle doors, operators, fork trucks and the like.

### BACKGROUND

Loading docks often have several types of equipment that are used together to conduct loading and unloading operations of trucks and trailers serviced at the loading dock. Many loading docks are equipped with multiple bays to accommodate the loading and unloading of multiple vehicles (trucks and trailers) at the same time. Examples of some of the types of equipment used at a loading dock include: upward acting doors, operators for the upward acting doors, vehicle restraints, a lock leveler, cameras, indicator lights, vehicle doors, operators, fork trucks and the like. Not all loading docks may use all of the listed equipment, and some may use additional equipment not listed, or various subsets of the equipment described herein. Much of this equipment is controlled, monitored and operation by separate control systems. In order to provide a safe and efficient loading dock environment, improvement in operation of various types of dock equipment is desired.

### SUMMARY

The foregoing needs are met to a great extent by embodiments in accordance with the present disclosure, wherein, in some embodiments allows a single unified control system that monitors, controls and operates multiple pieces of loading dock equipment in a unified safe and effect manner. In some embodiments, coordination of the various types of dock equipment is achieved. Further in some embodiments, the unified control system may allow addition control, monitoring, action logging, information decimation and operation capability not previously available.

In one aspect, the disclosure describes a control system for a loading dock. The control system includes: a controller operatively connected to control at least three of the following pieces of loading dock equipment; an operator for an upward acting door; a vehicle restraint; a dock leveler; an operator for a vehicle upward acting door; and a camera; at least three of the following sensors operatively connected to the controller; an upward acting door position sensor; a vehicle restraint position sensor; a dock leveler position sensor; a fork truck location sensor; a vehicle upward acting door location sensor; and a shelter seal sensor; at least two of the following output devices operatively connected to the controller and configured to provide a visual output; a user display screen located proximate to the controller; a user display screen located remote from the controller; a vehicle display screen located in a vehicle; a driver light system configured to activate a first light to instruct a driver to move a vehicle away from the loading dock and active a second light to instruct a driver to keep the vehicle at the loading dock; and a user display screen located on a fork truck; and at least two of the following input devices operatively connected to the controller and configured allow a user to enter inputs into the controller; a user input located proximate to the controller; a user input located remote from the controller; a vehicle user input located in a vehicle; and a user input located on a fork truck, wherein the controller is configured to display data received from at least three of the sensors on at least one display screen and allow a user to control at least three of the pieces of loading dock equipment via at least two of the input devices.

In another aspect, the disclosure describes a control system for a loading dock. The control system includes: a controller operatively connected to control at least three of the following pieces of loading dock equipment; an operator for an upward acting door; a vehicle restraint; a dock leveler; an operator for a vehicle upward acting door; and a camera; the controller configured to receive signals from at least three of the following sensors operatively connected to the controller; an upward acting door position sensor; a vehicle restraint position sensor; a dock leveler position sensor; a fork truck location sensor; a vehicle upward acting door location sensor; and a shelter seal sensor; the controller configured to communicate with at least two of the following output devices operatively connected to the controller and configured to provide a visual output; a user display screen located proximate to the controller; a user display screen located remote from the controller; a vehicle display screen located in a vehicle; a driver light system configured to activate a first light to instruct a driver to move a vehicle away from the loading dock and active a second light to instruct a driver to keep the vehicle at the loading dock; and a user display screen located on a fork truck; and the controller configured to communicate with at least two of the following input devices operatively connected to the controller and configured allow a user to enter inputs into the controller; a user input located proximate to the controller; a user input located remote from the controller; a vehicle user input located in a vehicle; and a user input located on a fork truck, wherein the controller is configured to display data received from at least three of the sensors on at least one display screen and allow a user to control at least three of the pieces of loading dock equipment via at least two of the input devices.

In yet another aspect, the disclosure describes a method of controlling loading dock equipment. The method includes: engaging a vehicle with a vehicle restraint; detecting the status of the vehicle restraint with a vehicle restraint sensor; sending a signal to a controller that the vehicle restraint is engaged with the vehicle; opening a warehouse door; detecting with a sensor the status of the warehouse door; sending a signal to the controller that the warehouse door is open; deploying a dock leveler; detecting with a sensor if the dock leveler is deployed; sending a signal to the controller that the dock leveler is deployed; and sending a signal indicating that a vehicle is ready to be serviced when signals are sent to a controller indicating that the vehicle restraint is engaged with the vehicle, the warehouse door is in an open position and the dock leveler is deployed.

Optionally, the method may also include: stowing the dock leveler; detecting with a sensor that the dock leveler is stowed; sending a signal to the controller that the dock leveler is stowed; closing the warehouse door; detecting with a sensor that the warehouse door is closed; sending a signal to the controller that the warehouse door is closed; releasing a vehicle from a vehicle restraint; detecting with a sensor that the vehicle is released from the vehicle restraint; sending a signal to that controller that the vehicle is released from the vehicle restraint; and sending a signal from the controller that the vehicle is free to move away from the dock leveler when the control has received signals that the dock level is stowed, and the vehicle restraint is released.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is a partial, perspective view of a loading dock and warehouse in accordance with the present disclosure.

FIG. 2 is a front view of a display screen in accordance with the present disclosure.

FIG. 3 is a front view of a display screen in accordance with the present disclosure.

FIG. 4 is a is a front view of a display screen in accordance with the present disclosure.

FIG. 5 is a front view of a computer and screen in accordance with the present disclosure.

FIG. 6 is a schematic diagram of a control system in accordance with the present disclosure.

FIG. 7 is a flow chart illustrating steps in a method in accordance with the present disclosure.

FIG. 8 is a flow chart illustrating steps in a method in accordance with the present disclosure.

### DETAILED DESCRIPTION

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

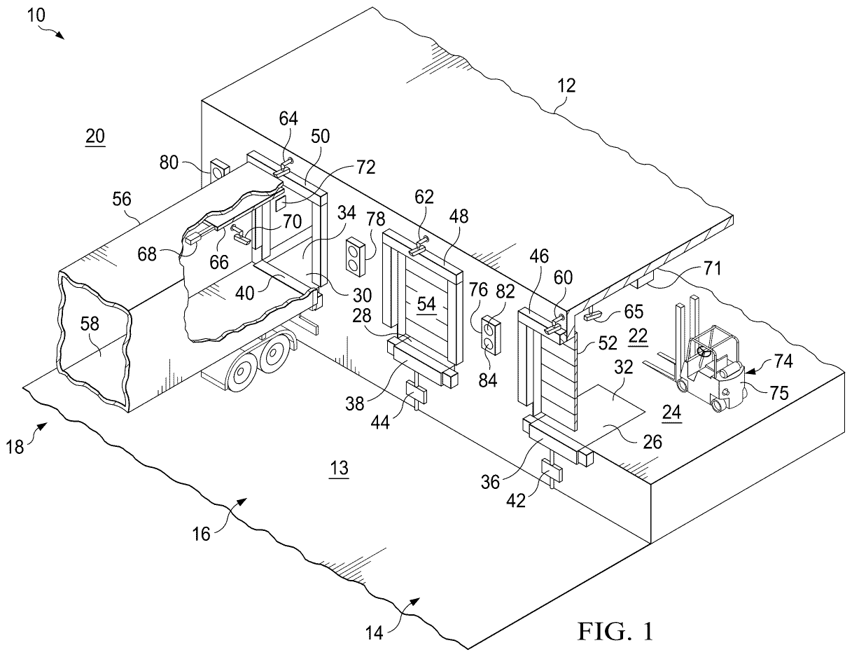

The present disclosure describes a system and method that permits a single control system to monitor and control several types of loading dock equipment. FIG. 1 is a partial perspective view of a loading dock 10. The loading dock 10 is connected to, and associated with, a warehouse 12. As shown in FIG. 1, the loading dock 10 includes bays 14 16 18, but in some embodiments the loading dock 10 may include only a single bay, two bays or more than the three bays 14 16 and 18 shown. The warehouse 12 has an outside 20 and inside 22. Inside the warehouse, the floor 24 can be seen with dock levelers 26 28 30 having floor plates 32 34 even with the floor 24.

The dock leveler lips 36 38 40 are located outside 20 of the warehouse 12. Also located outside 20 of the warehouse 12 are vehicle restraints 42 44. The vehicle restraint of bay 18 is obscured. The vehicle restraints 42 44 are represented in FIG. 1 as boxes due to the variety of different types of vehicle restraints 42 44 that may be used. For example, different types of vehicle restraints 42 44 may be used in various embodiments and may include the hook type that grabs onto the ICC bar (aka rear impact guard or “RIG”) of a vehicle, the swing type that also attaches to the ICC bar or RIG, wheel chocks, or any other suitable type of vehicle restraint 42 44. Because various types of vehicle restraints 42 44 are well known in the industry and vary in size, operation, and shape, FIG. 1 shows a representative box and refers to it as a vehicle restraint as it would crowd FIG. 1 to try to show all of the types of vehicle restraints 42 44 that could be used.

Dock seals/shelters 46 48 50 are located outside 20 the warehouse 12 and surround the upward acting dock doors 52 and 54 (upward acting dock door for bay 18 is moved to an upward position and is not seen in FIG. 1.

A partial cutaway view of a trailer 56 (also referred to herein as a vehicle 56 or truck/trailer 56 or truck or trailer) is shown in FIG. 1. The vehicle or trailer 56 is located in bay 18 and is attached to the loading dock 10 by a vehicle restraint (which is obscured by the vehicle or trailer 56, but the vehicle restraints for bays 14 and 16 are shown) and cannot be seen in FIG. 1. The truck or trailer 56 as a floor 58 upon which a lip 40 of the dock leveler 30 rests. The combination of the lip 40 and the floor plate 34 of the dock leveler 30 provide a bridge or transition between the floor 58 of the truck or trailer 56 to the floor 24 of the warehouse 12. The bridge or transition formed by the dock leveler 30 allows or relatively easy loading and unloading of the truck or trailer 56 and the warehouse 12.

When the vehicle 56 is backed up to the warehouse 12, the door seals/shelters 46 48 50 provide a seal or semi-seal between the vehicle 56 and the warehouse 12. The seal or semi-seal can provide a barrier to inhibit air conditioned air or heated air to avoid escaping the warehouse 12, inhibit rain, snow, or other weather from entering the warehouse 12, and also act as a security barrier to prevent or inhibit unauthorized access to the warehouse 12 or vehicle 56. Typical well known door seals/shelters 46 48 50 may be used or other suitable seals/shelters may be used.

Camera's 60 62 64 are shown for each bay 14 16 18 outside 20 of the warehouse 12. Interior cameras 65 may also be used. In other embodiments, cameras 60 62 64 65 maybe located at various locations inside 22 and/or outside 20 the warehouse 12 and by be oriented to photograph and/or video any area desired to be monitored. Further, the cameras 60 62 64 65 may be mounted in a movable way so that they can be controlled to change orientation to be able to monitor different areas. Further, they may be configured to be able to zoom in or out to capture desired images. The cameras 60 62 64 65 may monitor loading dock operations, loading dock equipment status and location, movement of freight, and/or monitor security issues such as people or material entering and leaving the warehouse 12 and/or loading dock 10 area.

A vehicle such as a truck or trailer 56 is parked in a bay 18 of the loading dock 10. The vehicle 56 is secured to the warehouse 12 by a vehicle restraint (such as 42 or 44 but the actual vehicle restraint attaching the vehicle 56 is not shown as it is hidden in the view of FIG. 1). The vehicle 56 may be retained in accordance with typical vehicle restraints or any other suitable vehicle restraint. Once the vehicle 56 is restrained, the vehicle door 66 is opened either manually or, if so equipped, via a vehicle door operator 68.

In some embodiments a vehicle camera 70, or in some embodiments, cameras 70, maybe located at various locations inside and/or outside the vehicle 56 and may be oriented to video any area desired to be monitored. Further, the camera(s) 70 may be mounted in a movable way so that they can be controlled to change orientation to be able to monitor different areas. Further, they may be configured to be able to zoom in or out to capture desired images. The camera(s) 70 may monitor loading dock operations, loading dock equipment status and location, movement of freight, and/or monitor security issues such as people or material entering and leaving the vehicle 56 and/or loading dock 10 area.

The vehicle (or truck/trailer) 56 is equipped with a vehicle door 66. As shown FIG. 1 the vehicle door 66 is an upward acting door 66 but other types of doors (for example, but not limited to, roll-up doors, spiral doors, so called “barn type” door or any other suitable door) may be used. Some vehicles 56 may be equipped with a vehicle door operator 68. The vehicle door operator 68 is attached to and configured to selectively open and close the vehicle door 66. In some embodiments the vehicle camera(s) 70 may be configured to capture images indicative of whether the vehicle door 66 is opened or closed.

The dock doors 52 54 may be opened and closed via operators 71 (only the operator 71 associated with dock door 52 is shown in FIG. 1). The door operators 71 may move the dock doors 52 54 to open and closed positions. Depending upon the type of door the dock door 52 54 is, the movement will be upward acting, roll-up, swing, or other movement as suited for a particular embodiment. Generally, each door 52 54 is associated with its own operator 71 as is known.

In some embodiments, a control panel 72 may be mounted to the warehouse 12 and operatively connected to many different sensors and warehouse equipment in order to monitor and control various pieces of warehouse equipment. In some embodiments, the control panel 72 may contain circuitry and a controller for the dock equipment and may also be referred to herein as the controller 72. The control panel 72 will be explained in further detail later below.

Many warehouses 12 use fork lifts 74 (also referred to as fork trucks 74) to load and unload vehicles 56 and move cargo within the warehouse 12. In accordance with some embodiments described in the present disclosure, fork trucks 74 made be equipped with a communication device 75, such as a transceiver or other communication device, operatively connected to the control panel 72 to inform the control panel 72 of the location of the fork truck 74 (or in some embodiments, fork trucks 74) and other fork truck operating data. The fork truck 74 operator may also receive information from the controller 72 via the communication device 75.

In some embodiments, bay instruction lights or signs 76 78 80 are mounted to the warehouse 12 or located else in a suitable location to allow a vehicle 56 operator see the lights or signs 76 78 80 to instruct the operator whether to stay at in the loading bay 14 16 18 or drive away. For example, the lights or signs 76 78 80 may be operably connected wirelessly or by wire to the controller 72. The controller 72 will send signals to control the lights or signs 76 78 80. When lights are used, a red light 82 may illuminate to indicate the operator should keep the vehicle 56 in the bay 14 16 18. A green light 84 may be luminated to indicate that an operator is free to pull away. Alternatively, the instruction lights or signs 76 78 80 may display specific instructions on a screen to an operator with a vehicle 56 located in a particular bay 14 16 18.

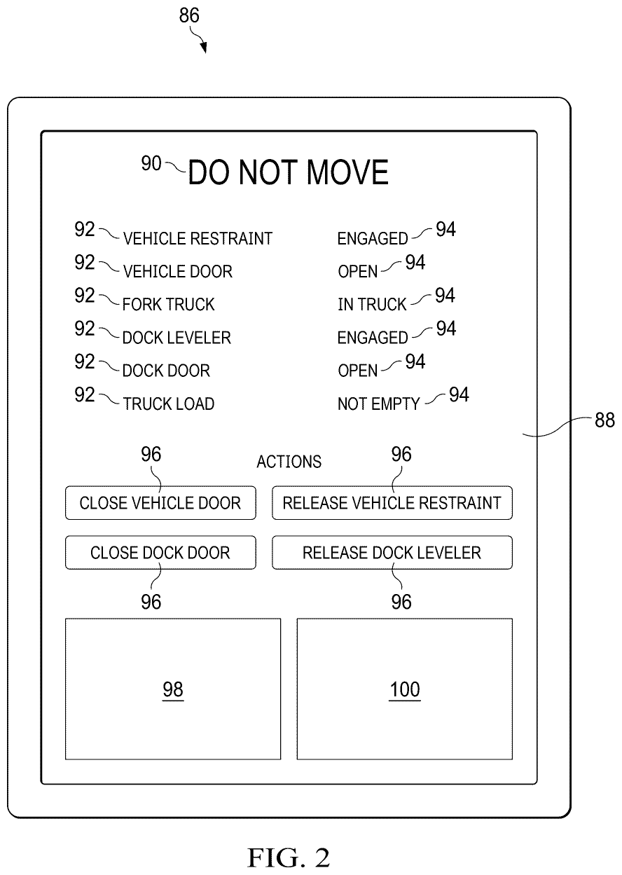

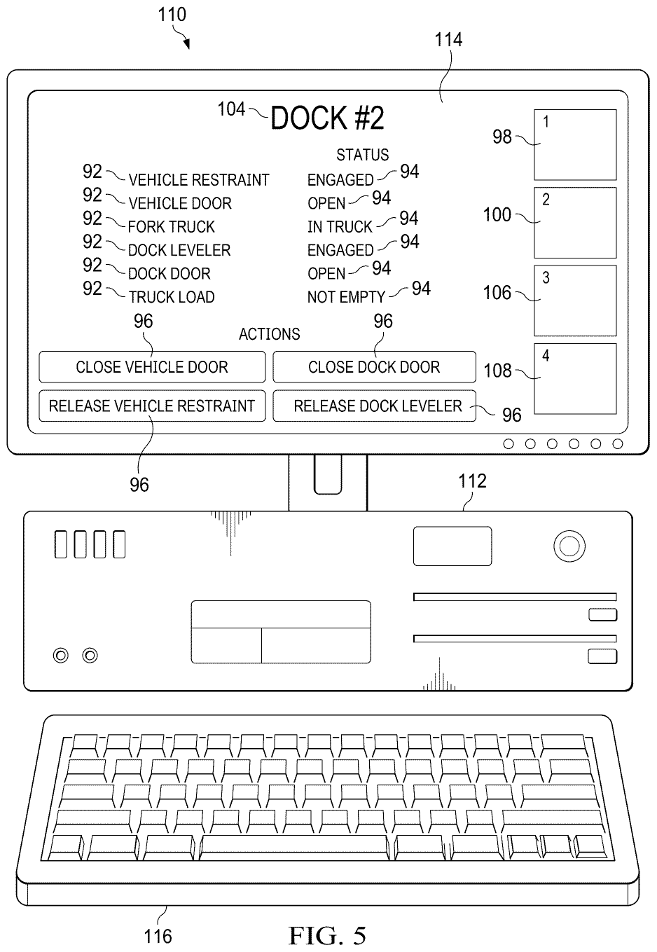

In some embodiments and as shown in FIGS. 2-5, a display device 86 is operatively connected to the controller 72 via wired or wireless connection. The display device 86 is configured to display information via a screen 88 as dictated by the controller 72 to a user. The display device 86 may also include a user input configured to allow user inputs to the controller 72. Examples of user inputs may include the screen 88 being a touch screen (as shown in FIGS. 2-4), a keyboard 116 shown in FIG. 5 and explained in more detail later below) buttons or other suitable user inputs.

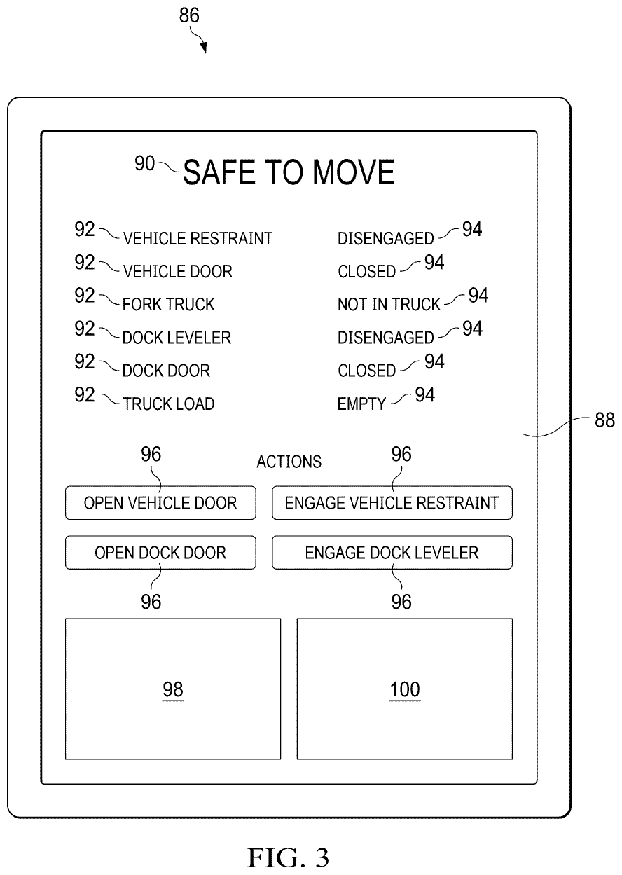

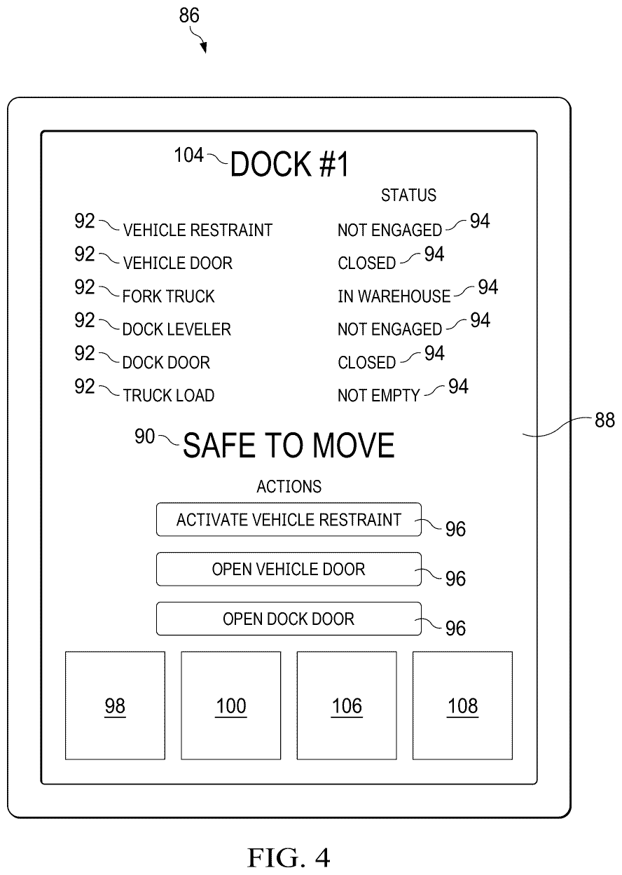

There may be several display devices 86 operatively connected to the controller 72. The display devices 86 may be located in a variety of places. For example, the display devices 86 shown in FIGS. 2-3 may be located in a cab of a vehicle 56 for use by the operator and may be calibrated or associated for a specific bay 14 16 18 or will indicate which bay 14 16 18 the information displayed pertains to. FIG. 4 shows an example display device 86 that can be located on a fork truck 74 for the use of a fork truck operator but is not limited to that location. The display device 86 of FIG. 4 could also be used at the control panel 72 or any other location where it would be desirable to view status information or control equipment for various bays 14 16 18. FIG. 5 shows yet another type of display device as a screen 114 that is part of a personal computer 112. After reviewing this disclosure, one ordinary skill in the art will understand that the various example display devices 86 110 shown in FIGS. 2-5 can be adapted, interchanged and modified for various applications and are not limited to the exact configurations illustrated and described herein.

As shown in FIGS. 2-5, a display device 86 can also be located in a warehouse 12 near or on the control panel 72 or any other suitable location for use by operators of the loading dock system 10. In some embodiments, the controller 72 may be accessed (via the internet, Bluetooth, Wi-Fi, a wired connection, or any other connection system) on a computer, tablet computer, smart phone, or any other personal device and thereby turning that device into a display device 86.

The display device 86 in FIG. 2 shows an example display screen 88 when conditions do not permit a vehicle 56 driver in a particular bay 14 16 18 to move the vehicle 56 out of the bay 14 16 18. The display device 86 in FIG. 3 shows an example display screen 88 when conditions do permit a vehicle 56 driver in a particular bay 14 16 18 to move the vehicle 56 out of the bay 14 16 18. The display screen 88 on the display device 86 shows several types of data and/or messages. The display screen 88 may also display video or still photo feeds 98 100. In some embodiments selection of a particular video feed 98 100 may allow the full screen 88 to display the video feed 98 100. Selection of a particular video feed 98 100 may allow an operator to control cameras 60 62 65 70 to zoom in/out, focus, pan, record or any other desired function. Further, in some embodiments, selecting any piece of information on the display screen 88 may allow a user to drill down and find additional information regarding the selection made.

FIG. 4 shows an alternate display screen 88. The display screen of FIG. 4 may be used for a variety of bays 14 16 18 and therefore an indicator 104 shows which bay 14 16 18 the other information on the screen 88 pertains to. Optionally, a user may select the indicator 104 and select other bays 14 16 18 to control and view information regarding.

The display screen of FIG. 4 shows an instruction banner 90 informing whether it is appropriate for a vehicle 56 operator to pull a vehicle 56 away from of a particular loading bay 14 16 18 as indicated by the bay indicator 104 or whether the vehicle 56 should remain in place. The display screen 88 may also list devices 92 and list the device status 94. The display screen 88 may show actions 96 that are eligible to be taken either automatically or selected to be taken by an operator of the controller 72. The display screen 88 may also display additional video or still photo feeds 106 108 than the photo or video feeds shown in the display device 86 of FIGS. 2-3.

In some embodiments, selection of a particular video feed 98 100 106 108 may allow the full screen 88 to display the video feed 98 100 106 108. Optionally, the display device 86 may display no video feeds or any number of video feeds as the number of feeds is not limited by the amount shown in the FIGS. Specific video feeds 98 100 106 108 may be selected for display and control. Selection of a particular video feed 98 100 106 108 may allow an operator to control cameras 60 62 65 70 to zoom in/out, focus, pan, record or any other desired function. Further, in some embodiments, selecting any piece of information on the display screen 88 all allow a user to drill down and find additional information regarding the selection made.

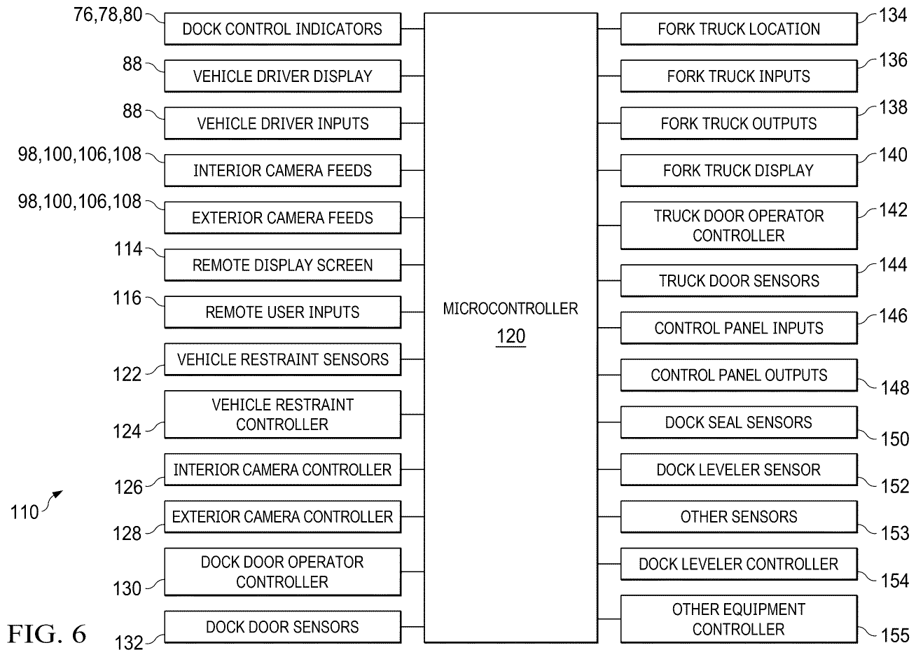

In some embodiments of the present disclosure, a remote dock controller 110 may be located remotely from the controller 72 and may be used in addition to or instead of the controller 72. When used in addition to the controller 72, the remote controller 110 may be operatively connected to the controller 72. Similarly to what is described with respect to a remote display device 86, a remote controller 110 may include a remote display device 86 but may also include a programable microcontroller 120 (see FIG. 6) configured to perform not just display functions but also control functions. The remote controller 110 may be operably connected to a dock control system 118 (See FIG. 6) via the internet, Bluetooth, Wi-Fi, a wired connection, or any other connection system. In some embodiments, a remote controller 110 may be any of: a computer, tablet computer, smart phone, or any other personal device operatively connected to the controller 72 and thereby turning that device into a remote controller 110.

The remote controller 110 shown in FIG. 5 is shown as a personal computer (PC) having a computer portion 112 (sometimes referred to as a tower) a screen 114, a keyboard 166 shown in FIG. 5 or other input device. Some embodiments, the screen 114 may be touchscreen and thereby include an input device. Other suitable input devices may also be used.

FIG. 6 is a schematic diagram of a dock control system 118 in accordance with the present disclosure. The dock control system 118 includes a microcontroller 120. The microcontroller 120 my reside within or be operatively connected to the control panel or controller 72 (shown in FIG. 1). The microcontroller 120 will be described as operatively connected or simply connected to various components in the following description. It should be understood that in this context, connected and operatively connected are intended to mean the same thing and not describe different types of connections and may refer to direct and indirect connections. The connections may be wired or wireless connections and allow signals to be transmitted to the microcontroller 120 and in many or all instances from the microcontroller 120 to the various components described. In some embodiments, the components may be uniquely identified in order to allow the microcontroller 120 to associate the components with a particular bay 14 16 18, vehicle 56, camera 60 62 64 65, remote display device 86, remote dock controller 110 and the like in order to control and/or receive input from specific components.

In some embodiments, vehicle restraint sensors 122 are operably connected to the microcontroller 120. The vehicle restraint sensors 122 are configured to send signals to the microcontroller 120 to indicate whether a particular vehicle restraint 42 44 is in an engaged or disengaged position and/or whether the vehicle restraint 42 44 is engaged or disengaged with a vehicle 56. It should be understood that while the term sensors is used in the plural, a single sensor or multiple sensors may be used in accordance with the present disclosure. This is true of other equipment described as well. The singular or plural forms of words are not meant to be limiting.

Interior and exterior camera controls 126 128 for controlling the various cameras 60 62 64 65 70 are operatively connected to the microcontroller 120 for allowing the microcontroller 120 to control the orientation, field of view, and other aspects of the cameras 60 62 64 65 70 and for receiving photo, video, and audio data from the cameras 60 62 64 65 70.

The door operators 71 may include door operator controllers 130 that control the door operators 71 to open or close the dock doors 52 54. Dock door sensors 132 which may be separate or integrated with the door operators 71 are configured to determine whether the dock doors 52 54 are open or closed, and in some embodiments in an in between state. The microcontroller 120 is operatively connected to the door operator controller 130 and dock door sensors 132 so that the dock control system 118 via the microcontroller 120 can determine the status of the dock doors 52 54 and determine how to operate the door operator 71 and ultimately the dock doors 52 54.

Optionally, a fork truck 74 location sensor 134 is operatively connected to the microcontroller 120 and transmits the location of a fork truck 74 to the microcontroller 120. When multiple fork trucks 74 are used each fork truck 74 may be equipped with a truck location sensor 134 for transmitting the location of the various fork trucks 74 to the microcontroller 120.

In accordance with some embodiments, fork trucks 74 may also be fork truck inputs 136, outputs 138, and a display 140 which are all operatively connected to the microcontroller 120 which allow a fork truck 74 operator to receive data from the microcontroller 120 and also input data. For example, remote display devices 86 with screens 88 such as shown and described with respect to FIGS. 2-4 may be located in the fork trucks 74. The fork trucks 74 may be associated with certain bays 14 16 18 or free to roam between bays 14 161 18 in which case the remote display devices 86 and screens 88 will display loading dock information 104 such as a unique dock or bay 14 16 18 identifier (such as a dock or bay 14 16 18 number) to allow a user to know which dock or bay 14 16 18 the loading dock pertains to allow a fork truck 74 operator to know which bay the information on the remote display screen 88 is applicable.

The vehicle 56 door operators 68 may include door operator controllers 142 that control the door operators 68 to open or close the doors 66 associated with various vehicles 56 located in various bays 14 16 18. Vehicle door sensors 144 which may be separate or integrated with the vehicle door operators 68 are configured to determine whether the vehicle doors 66 are open or closed, and in some embodiments, in an in between state. The microcontroller 120 is operatively connected to the vehicle door operator controller 142 and vehicle door sensors 144 so that the dock control system 118 via the microcontroller 120 can determine the status of the vehicle doors 66 and determine how to operate the vehicle door operator 68 and ultimately the vehicle doors 66.

Control panel 72 user inputs 146 and outputs 148 are operatively connected to the microcontroller 120. The control panel inputs 146 may include a keypad, buttons, a touch screen and/or any other suitable input. The outputs 148 may include a screen located at the control panel 72. Control panel user inputs 146 and outputs 148 allows an operator to gather data from and control the system 118 right at the control panel 72 and may be part of a display device 86 located at the control panel 72.

Optionally, dock seal sensors 150 are operatively connected to the microcontroller 120. In some embodiments, the dock seal sensors 150 are configured to detect of a vehicle 56 is contacting or proximate to a dock seal/shelter 46 48 50 and/or properly sealed to a dock seal/shelter 46 48 50. In other embodiments, other types of sensors may be used such as proximity sensors, weight sensors located in the pavement of the bay 14 16 18, or any other suitable type of sensor to detect if a vehicle 56 is located in a bay 14 16 18 of a loading dock 10.

In some embodiments, the dock control system 118 includes dock leveler sensor(s) 152 and dock leveler controller(s) 154 operatively connected to the microcontroller 120 for detecting the position or condition of the dock leveler 26 28 30 and allowing the microcontroller 120 to operate the dock leveler 26 28 30. The dock leveler sensor(s) 152 maybe be separate from or integrated with the dock level controller 154.

In some embodiments, the dock control system 118 may be operated manually by an operator reviewing the data set forth on the display screen 88 and then inputting commands to control various pieces of equipment. In other embodiments, the dock control system 118 may be automated or at least partially automated.

Optionally, other sensors 153 may be operatively connected to the microcontroller 120. The other sensors 153 can be used to sense the status of other dock equipment and/or environmental conditions that may be desired to be monitored by the control system 118. For example, undesirable conditions may be sensed in the warehouse such as temperature extremes, (heat or cold), water (or other fluid) on the floor 24, unacceptable levels of CO² in the warehouse. In such instances other equipment controllers 155 may be activated by the control system 118 to operate other pieces of equipment such as fans, HVAC systems, ventilation systems, pumps and the like, to mitigate the detected undesirable conditions detected by the other sensors 153.

The operation of the other equipment controllers 155 may be done automatically when the other sensors 153 detect the undesirable conditions exceeding thresholds programed into the microcontroller 120 or system 118 may alert a system user that the thresholds are exceeded, and the user may manually operate the other equipment controller 115 either via the system 118 or directly. Alternatively, there may not be any thresholds, rather the system 118 displays the data detected by the other sensors 153 and a system user takes action when the user deems it necessary.

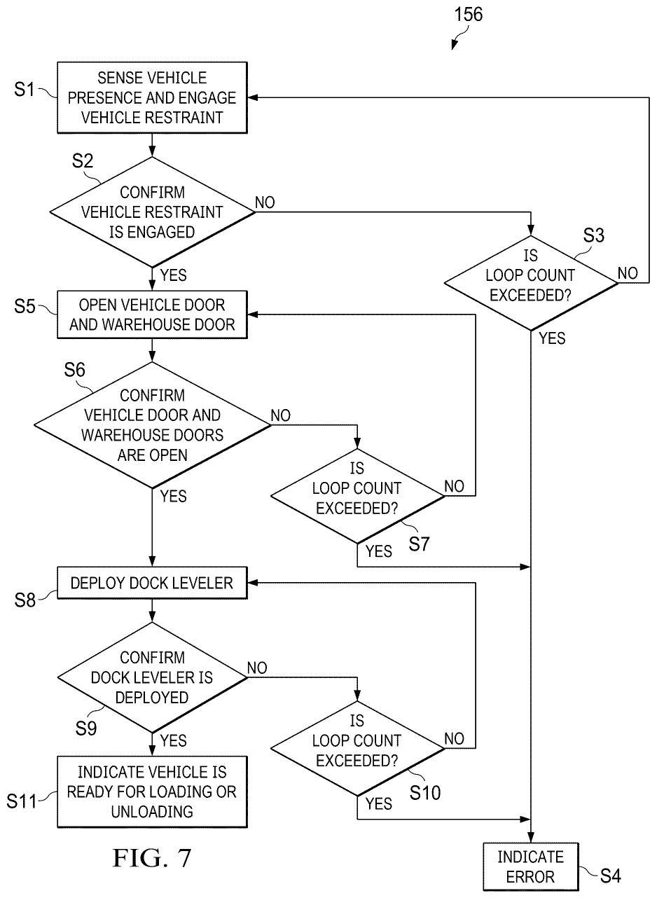

FIG. 7 is a flow chart that illustrates a method 156 to control the dock control system 118 to prepare a vehicle 56 for loading and/or unloading. At step S1, sensors associated with the dock control system 118 sense a vehicle 56 presence and engage a vehicle restraint 42 44. This step S1, may be accomplished by the dock seal sensors 150 sensing a vehicle 56 compressing a particular dock seal/shelter 46 48 50 and transmit a signal to the microcontroller 120 informing the microcontroller 120 that a vehicle 56 is located at a particular bay 14 16 18 (by the nature of which dock seal/shelter 46 48 50 sensor 150 was activated). In other embodiments other types of sensors may be used such as proximity sensors, weight sensors located in the pavement of the bay 14 16 18, or any other suitable type of sensor.

Once the microcontroller 120 receives a signal indicating that a vehicle 56 is located in a bay 14 16 18 the microcontroller 120 send a control signal to the vehicle restraint 42 44 associated with the bay 14 16 18 in which the vehicle 56 is detected to engage the vehicle restraint 42 44 with the vehicle 56.

Optionally, at step S2 the microcontroller 120 will receive a signal confirming the vehicle restraint 42 44 is engaged with the vehicle 56. This signal may come automatically or as a response to a query. If there is no confirmation the restraint 42 44 is engaged, the microcontroller 120 may again send a signal to engage the vehicle restraint 42 44 and query again if the restraint 42 44 is engaged and continue to do so until a count in a loop counter is met as in step S3. If the loop count in step S3 is met, the microcontroller 120 may determine that the vehicle restraint 43 44 is in an error condition at step S4 and display the error on the display screens 88.

If the microcontroller 120 receives a confirmation signal that the vehicle restraint 42 44 is engaged with a vehicle 56 before the loop count at step S3 is met, the microcontroller 120 will send a control signal to a warehouse door operator 71 and/or the vehicle door operator 68 to open at step S5. The warehouse door operator 71 and vehicle door operator 68 may have their own internal protocols to ensure it is appropriate to open the dock door 52 54 and/or vehicle door 66 and once satisfied, the operator 71 and vehicle door operator 68 will open the dock doors 52 54 and vehicle door 66.

At the next step S6, the microcontroller 120 will receive a signal from the dock door sensor(s) 132 and vehicle door sensor 144 that the dock door 52 54 and vehicle door 66 have moved to an open position. These signals may come automatically or as a response to queries. If there is no confirmation the dock door 52 54 and truck or vehicle door 66 is open, the microcontroller 120 may again send a control signal to move the dock door 52 54 and vehicle door 66 to an open position and query again if the dock door 52 54 and vehicle doors 66 are opened and continue to do so until a count in a loop counter is met in step S7. If the loop count in step S7 is met, the microcontroller 120 may determine that the dock door 52 54 or vehicle door 66 is in an error condition at step S4 and display the error on the display screens 88.

If the microcontroller 120 receives a confirmation signal that the dock door 52 54 and vehicle door 66 are open before the loop count at step S7 is met, dock control system 118 will advance to the next step, S8, where the microcontroller 120 will send a control signal to deploy the dock lever 26 28 30 associated with the opened dock door 52 54.

Optionally, at step S9 the microcontroller 120 will receive a signal confirming the dock leveler 26 28 30 is engaged with a vehicle 56. This signal may come automatically or as a response to a query. If there is no confirmation the dock leveler 26 28 30 is engaged, the microcontroller 120 may again send a control signal to deploy the dock leveler 26 28 30 and query again if the dock leveler 26 28 30 is engaged and continue to do so until a count in a loop counter is met as in step S10. If the loop count in step S10 is met, the microcontroller 120 may determine that the dock leveler 26 28 30 is in and error condition at step S4 and display the error on the display screens 88.

If the microcontroller 120 receives a confirmation signal that the dock leveler 26 28 30 is engaged before the loop count at step S10 is met, the microcontroller 120 will send a control signal to the display screens 88 indicating that the vehicle 56 is ready to load/unload at step S11.

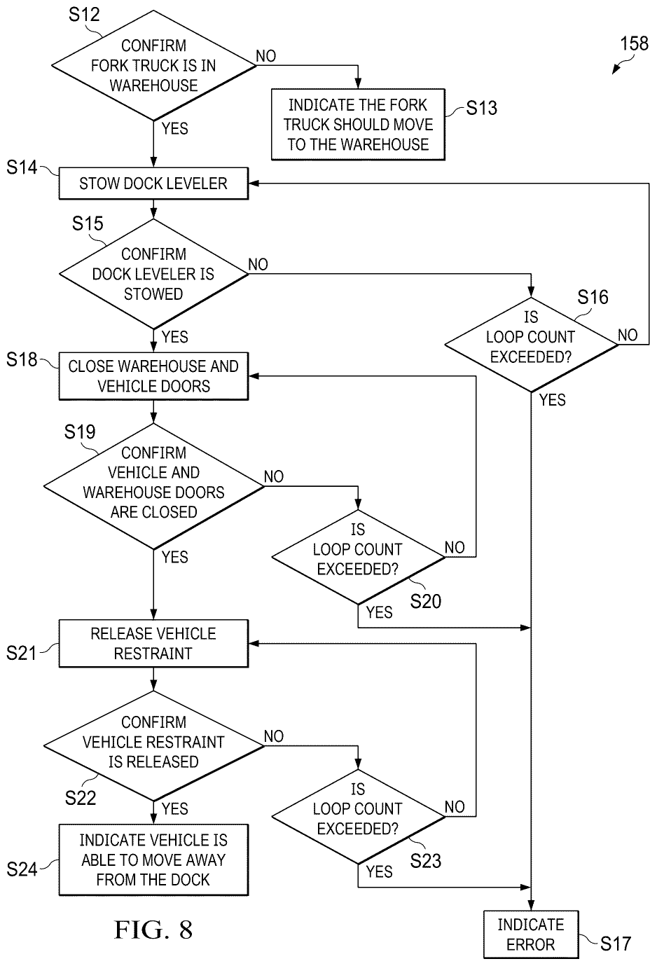

FIG. 8 shows a method 158 for preparing a vehicle 56 at a bay 14 16 18 at the warehouse 12 to leave after the vehicle 56 has been loaded or unloaded. A user inputs to the microcontroller 120 a command to initial the method 158 for preparing a vehicle 56 to leave a bay 14 16 18 at the warehouse 12. In the method 158 shown in FIG. 8 the dock control system 118 at its first step, step S12 confirms the fork truck(s) 74 is in the warehouse 12 or, at least not in the vehicle 56 or on the dock leveler 26 28 30. Specifically, the microcontroller 120 receives signals (either automatically or by query) from the fork truck 74 location sensor 134 (transceiver or transmitter) locations of the fork trucks 74(s) to ensure that no fork trucks 74 are located either in the truck/trailer 56 on the dock leveler 26 28 30 at the bay 14 16 18 for which the truck/trailer 56 is preparing to leave.

In some embodiments, the microcontroller 120 may ensure the fork truck 74 associated with the bay 14 16 18 for which the truck/trailer 56 is located is in the warehouse 12 and not in the truck/trailer 56, on the dock leveler 26 28 30 or on a portion of the loading dock 10 located outside the warehouse 12 if so equipped.

If the fork truck 74 is located not in the warehouse 12, (which may be interpreted as in the vehicle 56 or on the dock leveler 26 28 30) at step S13 the microcontroller 120 will send a signal that the fork truck 74 needs to move to the warehouse 12. This message may be displayed on the screens 88 114 of the remote display device 86, computer 112 and/or the fork truck output 138. Once the microcontroller 120 receives confirmation that the fork truck 74 is in the warehouse (or at another appropriate location to allow the vehicle 56 to leave the loading dock 10), the microcontroller 120 will stow the dock leveler 26 28 30 at step S14. The microcontroller will send a signal to the dock leveler controller 154 associated with the dock leveler 26 28 30 associated with the bay 14 16 18 in which the vehicle 56 is preparing to leave the dock 10.

Optionally, the microcontroller 120 will receive confirmation that the dock leveler 26 28 30 is stowed at step S15. The signal may come from the dock leveler controller 154 or sensors 152 automatically or as a response to a query. If there is no confirmation signal that the dock lever 26 28 30 is stowed, the microcontroller 120 may again send a control signal to stow the dock leveler 26 28 30 and query again if the dock leveler 26 28 30 is stowed and continue to do so until a count in a loop counter is met in step S16. If the loop count in step S16 is met, the microcontroller 120 may determine that the dock lever 26 28 30 is in an error condition at step S17 and display the error on the display screens 88.

Once the microcontroller 120 receives a signal indicating that the dock lever 26 28 30 is stowed, the microcontroller 120 at step S18 will send a command signal to the dock door operator controller 130 and, optionally, to the vehicle door controller 142 to close the dock door 52 54 or vehicle door 66. The dock door operator 71 and vehicle door operator 68 may conduct internal protocol procedures to determine if it is appropriate to close the dock door 52 54 or vehicle door 66 before the operators 68 71 close the dock door 52 54 or vehicle door 66.

Once the dock door 52 54 or vehicle door 66 is closed, the microcontroller 120 will received a signal confirming the appropriate dock door 52 54 and/or vehicle door 66 is closed at step S19. The signal may come from the dock door controller 130, vehicle door controller 142, or door position sensors (if so equipped) automatically or as a response to a query. If there is no confirmation signal that the dock door 52 54 30 or vehicle door 66 is closed, the microcontroller 120 may again send a control signal to close the dock door 52 54 or vehicle door 66 and query again if the dock door 52 54 or vehicle door 66 is closed and continue to do so until a count in a loop counter is met in step S20. If the loop count in step S20 is met, the microcontroller 120 may determine that the dock door 52 54 or vehicle door 66 is in an error condition at step S17 and display the error on the display screens 88.

Once the microcontroller 120 receives a signal indicating that the dock door 52 54 or vehicle door 66 is closed, the microcontroller 120 at step S21 will send a command signal to the vehicle restraint controller 124 and to command the vehicle restraint 42 44 to disengage from the vehicle 56 (also referred to herein as a truck/trailer 56) that is preparing to leave the loading dock 10. The vehicle restraint controller 124 may conduct internal protocol procedures to determine if it is appropriate to close disengage from the vehicle 56 before the vehicle restraint controller 124 disengages the vehicle restraint 42 44 from the vehicle 56.

Optionally, once the vehicle restraint 42 44 is disengaged from the vehicle 56, the microcontroller 120 will received a signal confirming the appropriate vehicle restraint 42 44 is disengaged at step S22. The signal may come from the vehicle restraint controller 124 or vehicle restraining sensors 122 (if so equipped) automatically or as a response to a query. If there is no confirmation signal that the vehicle restraint 42 44 is disengaged from the vehicle 56, the microcontroller 120 may again send a control signal to disengage the vehicle restraint 42 44 from the vehicle 56 and query again if the vehicle restraint 42 44 is disengaged from the vehicle 56 and continue to do so until a count in a loop counter is met in step S23. If the loop count in step S23 is met, the microcontroller 120 may determine that the vehicle restraint 42 44 is in an error condition at step S17 and display the error on the display screens 88.

Once the microcontroller 120 received confirmation that the vehicle restraint 42 44 is released, the microcontroller 120 will send a signal indicating that the vehicle 56 is able to move away from the dock 10 at step S24. The screens 88 may indicate the appropriate vehicle may move away from the loading dock 10. Further, when so equipped, bay instruction sign 76 78 80 for the appropriate bay 14 16 18 will indicate that the vehicle 56 is free to move away from the loading dock 10. In embodiments were the bay instruction signs 76 78 80 include red 82 and green 84 lights, the green 84 light maybe illuminated thereby indicating to the vehicle operator that the vehicle 56 is free to move away from the loading dock 10.

In some embodiments, when any piece of equipment is in an error condition, not only may an error message be displayed on display screens 88 114 and/or bay instruction lights 76 78 80 or other indicators, the error condition may also be indicated by audio indicators (bussers, tones or other audio alerts) flashing lights or other visual indicators.

It will be understood that the programming of the microcontroller 120 may be modified so that before, during or after the confirmation steps, the microcontroller 120 may or may not continue to send control signals to operate the equipment in accordance with the intended step until the microcontroller received confirmation that the equipment has been moved to the correct position according to the specific needs and requirements of a particular embodiment.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

I claim:

1. A control system for a loading dock comprising:
a controller operatively connected to control at least three of the following pieces of loading dock equipment;
an operator for an upward acting door;
a vehicle restraint;
a dock leveler;
an operator for a vehicle upward acting door; and
a camera;
at least three of the following sensors operatively connected to the controller;
an upward acting door position sensor;
a vehicle restraint position sensor;
a dock leveler position sensor;
a fork truck location sensor;
a vehicle upward acting door location sensor; and
a shelter seal sensor;
at least two of the following output devices operatively connected to the controller and configured to provide a visual output;
a user display screen located proximate to the controller;
a user display screen located remote from the controller;
a vehicle display screen located in a vehicle;
a driver light system configured to activate a first light to instruct a driver to move a vehicle away from the loading dock and active a second light to instruct a driver to keep the vehicle at the loading dock; and
a user display screen located on a fork truck; and
at least two of the following input devices operatively connected to the controller and configured allow a user to enter inputs into the controller;
a user input located proximate to the controller;
a user input located remote from the controller;
a vehicle user input located in a vehicle; and
a user input located on a fork truck,
wherein the controller is configured to display data received from at least three of the sensors on at least one display screen and allow a user to control at least three of the pieces of loading dock equipment via at least two of the input devices.

2. A control system for a loading dock comprising:
a controller operatively connected to control at least three of the following pieces of loading dock equipment;
an operator for an upward acting door;
a vehicle restraint;
a dock leveler;
an operator for a vehicle upward acting door; and
a camera;
the controller configured to receive signals from at least three of the following sensors operatively connected to the controller;
an upward acting door position sensor;
a vehicle restraint position sensor;
a dock leveler position sensor;
a fork truck location sensor;
a vehicle upward acting door location sensor; and
a shelter seal sensor;
the controller configured to communicate with at least two of the following output devices operatively connected to the controller and configured to provide a visual output;
a user display screen located proximate to the controller;
a user display screen located remote from the controller;
a vehicle display screen located in a vehicle;
a driver light system configured to activate a first light to instruct a driver to move a vehicle away from the loading dock and active a second light to instruct a driver to keep the vehicle at the loading dock; and
a user display screen located on a fork truck; and
the controller configured to communicate with at least two of the following input devices operatively connected to the controller and configured allow a user to enter inputs into the controller;
a user input located proximate to the controller;
a user input located remote from the controller;
a vehicle user input located in a vehicle; and
a user input located on a fork truck,
wherein the controller is configured to display data received from at least three of the sensors on at least one display screen and allow a user to control at least three of the pieces of loading dock equipment via at least two of the input devices.

3. The control system of claim 2, wherein the user input and the display screen include at least one of either a touch screen and a keyboard.

4. The control system of claim 2, wherein the user input and display screen are part of a personal device operatively connected to the controller.

5. The control system of claim 2, wherein one of the at least two output devices includes a driver light system configured to activate a first light to instruct a driver to move a vehicle away from the loading dock and active a second light to instruct a driver to keep the vehicle at the loading dock and the first light is a green light and the second light is a red light.

6. The control system of claim 2, wherein the controller is configured to operate so that the controller will not control the vehicle restraint to release the vehicle, until the fork truck location sensor indicates the fork truck to be inside a warehouse, the dock leveler position sensor indicates dock leveler is in a stowed position and the upward acting door sensor indicates the upward acting door is in a closed position.

7. The control system of claim 6, wherein the controller is configured to operate so that the controller will not control the vehicle restraint to release the vehicle, until the vehicle upward acting door sensor indicates the vehicle upward acting door is in a closed position.

8. The control system of claim 2, wherein the controller is configured to not indicate on any of the output devices clearance for the vehicle to move away from the loading dock until the vehicle restraint as moved to a vehicle release position.

9. The control system of claim 2 wherein the controller is configured to control a camera to alter a field of view with associated with the camera and stream images captured by the camera to at least one display screen.

10. The control system of claim 2, wherein the controller is configured to control and monitor equipment located at multiple bays of a loading dock.

11. The control system of claim 2, further comprising a data base operatively connected to the controller and configured to store user inputs, outputs, sensor inputs and loading dock equipment status.

12. The control system of claim 2, wherein the controller is configured to monitor the fork truck location sensor an keep the vehicle restraint in an engaged position whenever the fork truck location sensor indicates the fork truck is outside a warehouse associated with the loading dock.

13. The control system of claim 2, wherein the controller and display screen are configured to display both images captured by the camera and status of loading dock equipment at the same time.

14. The control system of claim 13, wherein the controller and the display screen are configured to also display dock equipment control commands being carried out by the control system at the same time as the images captured by the camera and the status of the loading dock equipment.

15. The control system of claim 2, wherein the controller and display screen are configured to display both data received from the sensors and dock equipment control commands being carried out by the control system at the same time.

16. A method of controlling loading dock equipment comprising:
engaging a vehicle with a vehicle restraint;
detecting a status of the vehicle restraint with a vehicle restraint sensor;
sending a signal to a controller that the vehicle restraint is engaged with the vehicle;
opening a warehouse door;
detecting with a sensor a status of the warehouse door;
sending a signal to the controller that the warehouse door is open;
deploying a dock leveler;
detecting with a sensor if the dock leveler is deployed;
sending a signal to the controller that the dock leveler is deployed; and
sending a signal indicating that a vehicle is ready to be serviced when signals are sent to a controller indicating that the vehicle restraint is engaged with the vehicle, the warehouse door is in an open position and the dock leveler is deployed.

17. The method of claim 16 further comprising after conducting the steps of claim 16:
stowing the dock leveler;
detecting with a sensor that the dock leveler is stowed;
sending a signal to the controller that the dock leveler is stowed;
closing the warehouse door;
detecting with a sensor that the warehouse door is closed;
sending a signal to the controller that the warehouse door is closed;
releasing a vehicle from a vehicle restraint;
detecting with a sensor that the vehicle is released from the vehicle restraint;
sending a signal to that controller that the vehicle is released from the vehicle restraint; and
sending a signal from the controller that the vehicle is free to move away from the dock leveler when the control has received signals that the dock level is stowed, and the vehicle restraint is released.

18. The method of claim 17, further comprising:
closing a vehicle door;
detecting with a sensor that the vehicle door is closed;
sending a signal to the controller that the vehicle door is closed; and
sending a signal from the controller that the vehicle is free to move away from the dock leveler when the control has received signals that the dock level is stowed, and the vehicle restraint is released and the vehicle door is closed.

19. The method of claim 17, further comprising:
before stowing the dock leveler, detecting a location of a fork truck and confirming that the fork truck is not located in the vehicle.

20. The method of claim 17, wherein:
the opening a warehouse door step also includes opening a vehicle door,
the detecting with a sensor the status of the door step also includes detecting with a sensor a status of the vehicle door,
the sending a signal to the controller that the warehouse door is open step also includes sending a signal to the controller that the vehicle door is open,
the closing the warehouse door step also includes closing the vehicle door,
the detecting with a sensor that the warehouse door is closed step also includes detecting with a sensor that the vehicle door is closed, and
the sending a signal to the controller that the warehouse door is closed step also includes sending a signal to the controller that the vehicle door is closed.
